(19) United States
(12) Patent Application Publication
(10) Pub. No.: US 2011/0251369 A1
(43) Pub. Date: Oct. 13, 2011

(54) PHOTOACTIVE GROUP-BONDED POLYSILSESQUIOXANE HAVING A LADDER STRUCTURE AND A METHOD FOR PREPARING THE SAME

(75) Inventors: Seung Sang HWANG, Seoul (KR); Kyung Youl BAEK, Seoul (KR); Seung-Sock CHOI, Gumi-si (KR); He Seung LEE, Seoul (KR); Albert S. LEE, Seoul (KR); Sungyoun OH, Seoul (KR)

(73) Assignee: KOREA INSTITUTE OF SCIENCE AND TECHNOLOGY, Seoul (KR)

(21) Appl. No.: 12/851,708

(22) Filed: Aug. 6, 2010

(30) Foreign Application Priority Data
Apr. 7, 2010 (KR) 10-2010-0031862

(51) Int. Cl. C08G 77/04

(52) U.S. Cl. 528/9; 528/10; 528/37

(57) ABSTRACT

Disclosed are a polysilsesquioxane having a ladder structure with photoactive groups bonded at the siloxane main chain, and a method for preparing the same.

Polysilsesquioxanes exhibiting superior thermal and mechanical properties and having various functionalities and characteristics depending on the photoactive groups introduced thereto may be prepared via a relatively simple method. The polysilsesquioxanes may be useful as an industrial material for organic-inorganic hybrid materials.

### CROSS-REFERENCE TO RELATED APPLICATION

This application claims priority to Korean Patent Application No. 10-2010-0031862, filed on Apr. 7, 2010, and all the benefits accruing therefrom under 35 U.S.C. §119, the contents of which in its entirety are herein incorporated by reference.

### BACKGROUND

1. Field

This disclosure relates to a polysilsesquioxane having a novel structure, specifically to a polysilsesquioxane having a ladder structure with photoactive groups bonded at the siloxane main chain, and a method for preparing the same.

2. Description of the Related Art

A hybrid material consisting of organic and inorganic components may exhibit significantly improved thermal, mechanical and chemical properties over the two components. Among various hybrid materials, polysilsesquioxane (PSQ) with the empirical formula (RSiO_{1.5})ₙ is particularly gaining attentions because of its ability to derive a controlled polysiloxane structure using various functional groups.

The controlled polysiloxane structure often shows very superior performance over organic based polymers. For example, a polyhedral oligomeric silsesquioxane (POSS) of the following formula having photoactive groups exhibits significantly improved photoluminescence efficiency over similar organic based polymers. Such a superior efficiency is due to the rigid main chain as compared to the organic based polymer, which allows the functional groups at the side chain to be freely separated [Imae I. and Kawakami Y. Journal of Materials Chemistry 2005; 15(43): 4581].

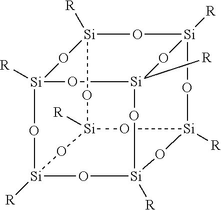

Most of functionalizations the siloxane structure have been made based on POSS. However, despite the various interesting phenomena of POSS, it does not make a practical material for use as a thin film in electronic devices such as organic light-emitting diodes (OLED) or organic photovoltaic cells because of low molecular weight, which results in relatively low glass transition temperature and melting point.

### SUMMARY

Accordingly, this disclosure is directed to providing a polysilsesquioxane having a novel ladder structure exhibiting superior thermal and mechanical properties and is appropriate for application to organic electronic devices such as organic light-emitting diodes (OLED) or organic photovoltaic cells, and a method for preparing the same.

In one aspect, there is provided a polysilsesquioxane having a ladder structure with photoactive groups bonded at the siloxane main chain, which is polymerized from a trifunctional silane compound having the photoactive group as monomer.

In another aspect, there is provided a method for preparing a polysilsesquioxane having a ladder structure with photoactive groups, including: (a) reacting a trifunctional silane compound with a photoactive compound to prepare a monomer; and (b) hydrolyzing and condensation polymerizing the monomer at the same time.

The disclosed polysilsesquioxane exhibits superior thermal and mechanical properties and may have various functionalities and properties depending on the photoactive groups introduced thereto. Therefore, it may be useful as an industrial material for organic-inorganic hybrid materials.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 shows a ¹H spectrum of a polysilsesquioxane prepared according to an embodiment;

FIG. 2 shows a ²⁹Si ¹H spectrum of a polysilsesquioxane prepared according to an embodiment;

FIG. 3 shows an FT-IR analysis result of a polysilsesquioxane prepared according to an embodiment;

FIG. 4 shows an X-ray diffraction (XRD) analysis result of a polysilsesquioxane prepared according to an embodiment;

FIG. 5 shows a thermal behavior of a polysilsesquioxane prepared according to an embodiment measured using a thermal gravimetric analyzer (TGA);

FIG. 6 shows a thermal behavior of a polysilsesquioxane prepared according to an embodiment measured using a differential scanning calorimeter (DSC);

FIG. 7 shows UV absorption and photoluminescence spectra of a solution sample of a polysilsesquioxane having a ladder structure with photoactive groups; and

FIG. 8 shows UV absorption and photoluminescence spectra of a thin film of a polysilsesquioxane having a ladder structure with photoactive groups.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

This disclosure relates to a polysilsesquioxane polymerized from a trifunctional silane compound with a photoactive group as monomer. The photoactive group may be any one adequate for application to an organic electronic device without particular limitation. For example, a substituted or unsubstituted phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, or a derivative thereof, may be included.

Alternatively, the polysilsesquioxane may be copolymerized from the monomers having different photoactive groups.

For example, the trifunctional silane compound may be one or more selected from a group consisting of 3-bromotrimethoxysilane (BTMS), 3-chlorotrimethoxysilane, 3-iodotrimethoxysilane, 3-bromomethyltrimethoxysilane, 3-chloromethyltrimethoxysilane, 3-iodomethyltrimethoxysilane, 3-bromoethyltrimethoxysilane, 3-chloroethyltrimethoxysilane, 3-iodoethyltrimethoxysilane, 3-bromopropyltrimethoxysilane, 3-chloropropyltrimethoxysilane and 3-iodopropyltrimethoxysilane, but is not limited thereto.

In one embodiment, the trifunctional silane compound monomer with a photoactive group for polymerizing the polysilsesquioxane may be represented by Chemical Formula 1:

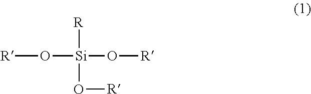

In the above formula, R may be one or more selected from a group consisting of phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, and a derivative thereof, which is connected to the Si atom directly or via an alkyl group, but is not limited thereto. R may be connected to the Si atom via a C₁-C₁₂ alkyl group. Any alkyl group having said number of carbon atoms may be present between R and the Si atom. And, R′ may be substituted or unsubstituted C₁-C₃ alkyl, but is not limited thereto.

In one embodiment, the polysilsesquioxane having a ladder structure with the photoactive groups may be represented by Chemical Formula 2:

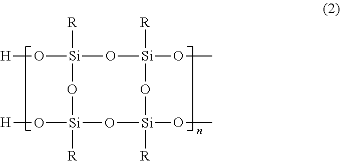

In the above formula, R is a substituted or unsubstituted phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, and a derivative thereof; and n is from 1 to 100,000.

In one embodiment, in Chemical Formula 2, R may be N-alkyl-substituted carbazole. The alkyl group of R may be C₁-C₁₂ alkyl. It may be any alkyl group having said number of carbon atoms.

The polysilsesquioxane having a ladder structure with the photoactive groups have high luminescence efficiency, as well as superior heat resistance and mechanical property.

It is because the polysilsesquioxane having a ladder structure has a rigid polymer structure, which allows a relatively longer distance between the photoactive groups attached to the silicon atoms, thereby allowing free movement and easy separation from the siloxane main chain. The rigid polymer structure and the long distance between the photoactive groups prevent the formation of an excimer resulting from π-π interaction.

In this regard, the inventors have confirmed that the rigid-structure polysilsesquioxane represented by Chemical Formula 3 wherein R is propylcarbazole has superior thermal stability. For instance, it is thermally stable even at a temperature as high as 400 to 500° C., and may have a glass transition temperature about 100° C. higher than the existing polyhedral oligomeric silsesquioxane (POSS).

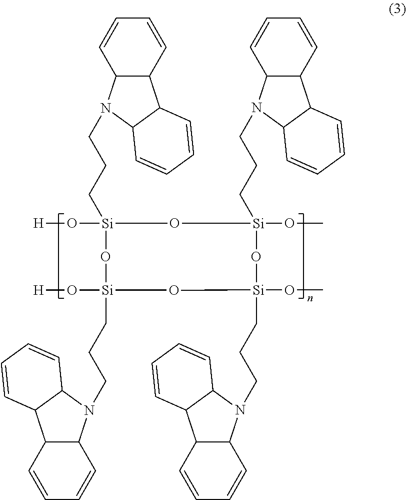

In the above formula, n is from 1 to 100,000.

In the polysilsesquioxane exhibiting such superior characteristics, the distance between the photoactive groups attached to the polysilsesquioxane having a ladder structure may be 13 to 16 Å, and the average thickness of the siloxane main chain may be 4 to 5 Å.

In addition, because of relatively larger molecular weight when compared with the existing POSS, it exhibits higher glass transition temperature and melting point and superior mechanical property, and is applicable to electronic devices such as organic light-emitting diodes (OLED), organic photovoltaic cells, or the like.

The disclosure relates to a method for preparing a polysilsesquioxane having a ladder structure with photoactive groups, comprising: (a) reacting a trifunctional silane compound with a photoactive compound to prepare a monomer; and (b) hydrolyzing and condensation polymerizing the monomer at the same time.

The preparation method includes the step (a) of reacting a trifunctional silane compound with a photoactive compound to prepare a monomer.

The photoactive compound and the trifunctional silane compound are the same as described above, and the monomer prepared by reacting the trifunctional silane compound with the photoactive compound is represented by Chemical Formula 1.

In one embodiment, the step (a) may be performed by reacting the trifunctional silane compound with the photoactive compound in a solvent at, for example, room temperature to 200° C., specifically 100° C. to 150° C. If the temperature is too high, structure control may be difficult during the polymerization. And, if the temperature is too low, the reaction may not proceed.

The solvent used in the reaction may be any commonly used organic solvent. For example, one which is not separated from aqueous solution and is completely miscible with a basic catalyst may be used. For example, one or more polar solvent(s) selected from a group consisting of tetrahydrofuran (THF), dimethylformamide (DMF), DMSO, DMAc, etc. may be used.

The step (a) may be performed in the presence of a catalyst. The catalyst may be any commonly used catalyst that can be used in the reaction of the trifunctional silane compound with the photoactive compound. For example, it may be one or more selected from a group consisting of KOH, NaOH, Na₂CO₃ and K₂CO₃.

The monomer prepared through the step (a) may be subjected to the reaction of the step (b). The preparation method according to this disclosure includes the step (b) of hydrolyzing and condensation polymerizing the monomer at the same time.

The step (b) may be performed at, for example, room temperature to 200° C., specifically 100° C. to 150° C. If the temperature is too high, polymer structure control may be difficult because the reaction proceeds too fast. And, if the temperature is too low, the reaction may not proceed.

The step (b) may be performed, for example, after purifying the product of the step (a), using the ion of the catalyst used in the step (a), e.g. K⁺ ion if the catalyst is K₂CO₃, without purification, or by adding another trifunctional silane monomer after the step (a).

### EXAMPLES

The examples and experiments will now be described. The following examples and experiments are for illustrative purposes only and not intended to limit the scope of this disclosure.

### Example

First, 3-bromopropyltrimethoxysilane (BPTMS) and carbazole were reacted in dimethylformamide (DMF) at 130° C. for 48 hours in the presence of K₂CO₃ to synthesize a 9-[3-(trimethoxysilyl)propyl]-9H-carbazole monomer. The monomer and K₂CO₃ were subjected to the next step without purification, except for removing the solvent and excess BPTMS using a vacuum evaporator. The monomer was dissolved again in DMF and then hydrolyzed at room temperature by adding 10 times the volume of water by single drip irrigation. As the monomer was hydrolyzed, the hydrolyzed monomer was simultaneously polymerized by condensation. One hour later, poly(propylcarbazole silsesquioxane) (PPCSQ) was obtained as yellow precipitate in solution.

### Experimental Example 1

Weight average molecular weight and molecular weight distribution of the PPCSQ prepared in Example were measured using a JASCO PU-2080 Plus SEC system equipped with an RI-2031 Plus refractive index detector and a UV-2075 Plus UV detector (detection wavelength: 254 nm). Measurement was made in THF at 40° C. at a flow rate of 1 mL/min. Sample was separated using four columns (Shodex GPC KF-802, KF-803, KF-804 and KF-805). SEC analysis revealed that the PPCSQ had a weight average molecular weight of 10,200 and a molecular weight distribution of 2.16.

### Experimental Example 2

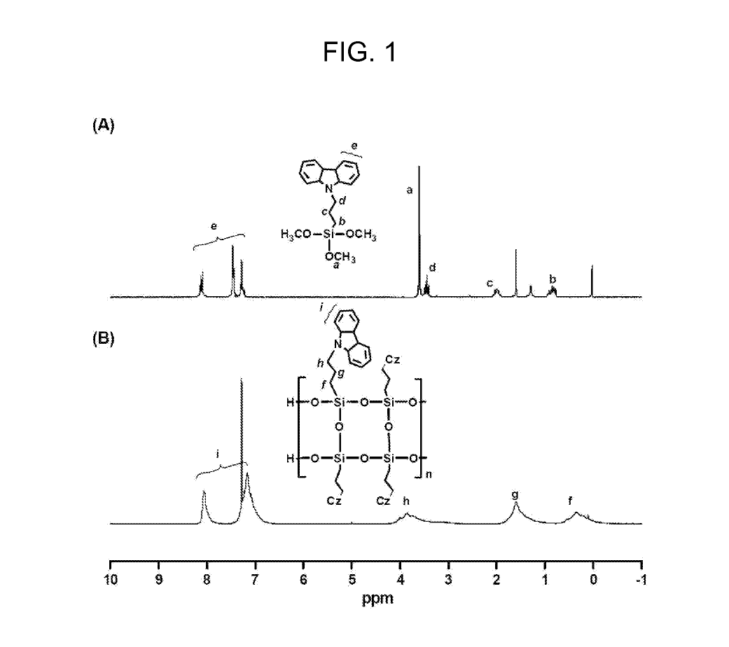

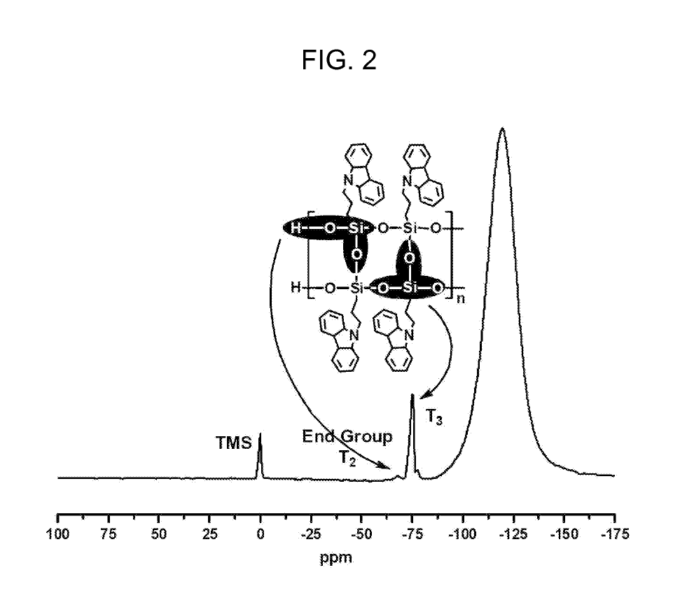

¹H and ²⁹Si spectra of the PPCSQ prepared in Example were recorded in CDCl₃ at 25° C. using Varian Unity Inova (¹H: 300 MHz, ²⁹Si: 99.5 MHz). FIG. 1 and FIG. 2 respectively show the ¹H spectrum and the ²⁹Si spectrum.

In FIG. 1, (A) and (B) respectively show ¹H spectra of the 9-[3-(trimethoxysilyl)propyl]-9H-carbazole monomer and the PPCSQ. The disappearance of the trimethoxy peak a and the broadened peaks f through i in (B) show that the completely hydrolyzed monomer was successfully condensation polymerized to yield the PPCSQ.

FIG. 2 shows the ²⁹Si NMR spectrum of the PPCSQ. The broad and large absorption peak at −70.6 to −79.2 ppm and the small downfield absorption peak respectively represent the T₃ structure of the siloxane bond [R—Si(OSi—)₃] and the T₂ structure of the siloxane bond [R—Si(OSi—)₂(OR′)]. With the increase of the T₃ structure, the defect of the siloxane bonding decreases. T₃: T₂ was calculated as 98% from the integration of the peaks. This result reveals that the majority of the hydroxyl groups of the hydrolyzed monomer participated in the condensation polymerization to give the PPCSQ having a ladder structure, and only a trace amount of hydroxyl groups remains at the end of the PPCSQ chain.

### Experimental Example 3

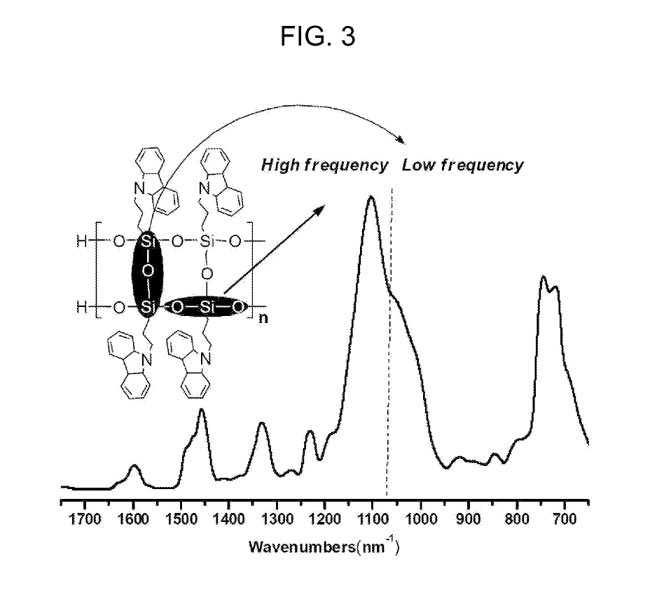

A Fourier transform infrared (FT-IR) spectrum of the PPCSQ prepared in Example was measured using a Perkin-Elmer FT-IR system (Spectrum GX), using a film solvent-cast on KBr pellets. The result is shown in FIG. 3.

Referring to FIG. 3, the FT-IR analysis result also reveals that the PPCSQ prepared in Example has a controlled ladder structure. A broad bimodal absorption peak was observed at 960 to 1200 cm⁻¹, which is due to the stretching vibration of the siloxane bonding of the PPCSQ in vertical (—Si—O—Si—R) and horizontal (—Si—O—Si—) directions. The well-defined peak close to 1200 cm⁻¹ due to the horizontal siloxane bonding reveals that the PPCSQ has a more ladder-like structure.

### Experimental Example 4

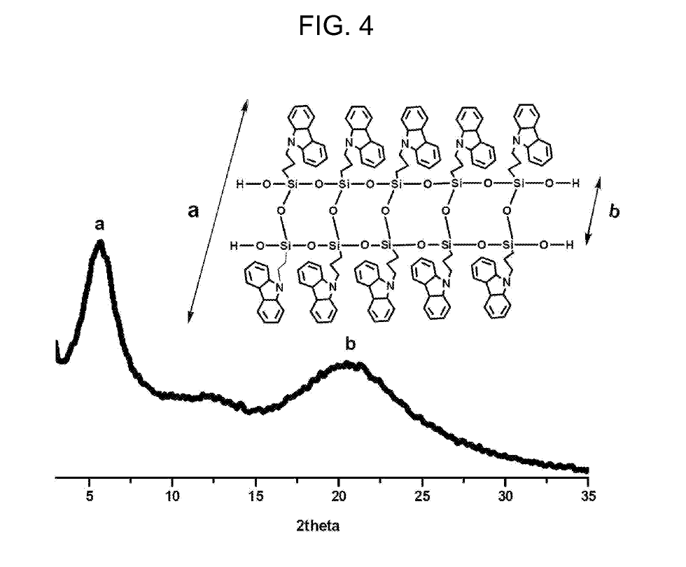

X-ray diffraction (XRD) analysis was performed to more precisely define the structure of the PPCSQ prepared in Example. The result is shown in FIG. 4.

Referring to FIG. 4, two characteristic diffraction peaks were observed at 5.66° (a) and 20.6° (b). The sharp peak (a) represents the periodical chain-chain distance (d₁=15.6 Å), i.e. the distance between two carbazole groups of the PPCSQ having the ladder-shaped siloxane main chain, whereas the diffuse peak (b) represents the average thickness of the siloxane main chain (d₂=4.3 Å).

### Experimental Example 5

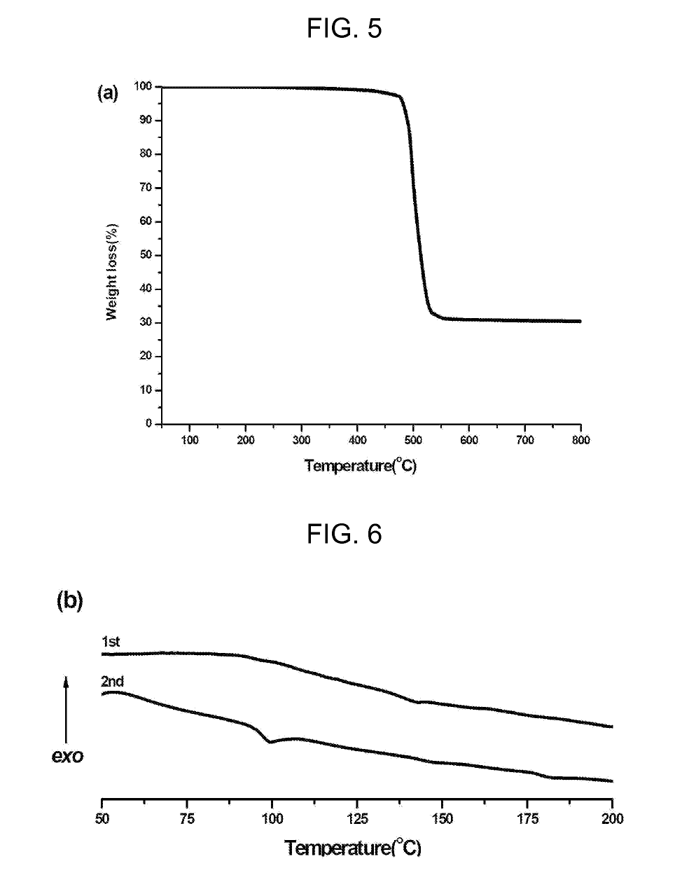

The thermal behavior of the PPCSQ prepared in Example was monitored using a thermal gravimetric analyzer (TGA) and a differential scanning calorimeter (DSC). The result is shown in FIG. 5 and FIG. 6.

FIG. 5 shows the monitoring result using a TGA, from 25° C. to 1000° C. at a scan rate of 10° C./min under nitrogen atmosphere. The slight weight loss (˜5%) from 300 to 450° C. is thought to be due to the decomposition of hydroxyl groups at the end of the PPCSQ chain. Thereafter, the weight was lost by ˜60% until 580° C. due to the decomposition of the propylcarbazole group. The remaining weight 35% was stable until 1000° C., which may be that of the remaining silica compound. This suggest that the PPCSQ is thermally more stable than the existing hydrocarbon-based poly(vinylcarbazole) (PVK), which is completely decomposed at 420 to 550° C.

FIG. 6 shows the monitoring result using a DSC, from 25° C. to 1000° C. at a scan rate of 10° C./min under nitrogen atmosphere. The DSC curve shows a single glass transition temperature at 95° C. during the second heating. This relatively low transition temperature confirms that the PPCSQ having the ladder structure is distinguished from POSS.

### Experimental Example 6

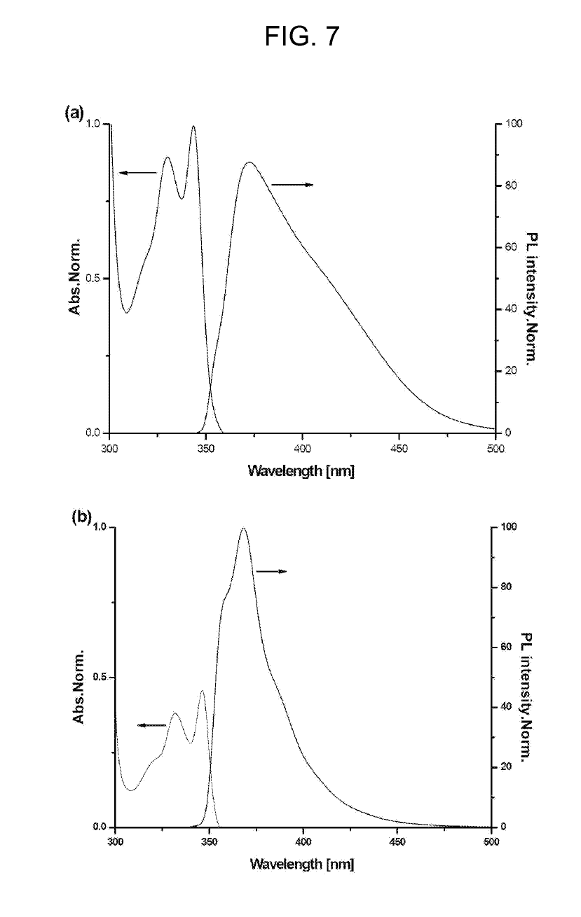

In order to test the electro-optical properties of the PPCSQ prepared in Example, the PPCSQ and the hydrocarbon-based PVK were added to THF (1×10⁻⁴ mol) to prepare solution samples. UV absorption and photoluminescence spectra were measured. The result is shown in FIG. 7.

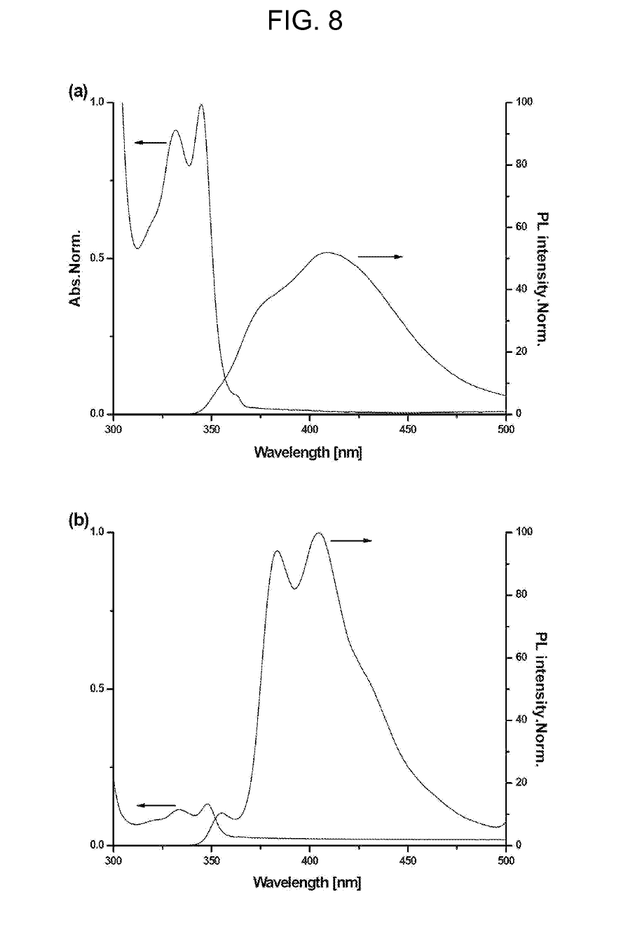

The PVK solution and the PPCSQ solution (1 wt % each) were spin coated on ITO glass and then dried in vacuum at 40° C. for 5 hours to prepare solid sample films. The film thickness was 200 nm. UV absorption and photoluminescence spectra of the PVK thin film and the PPCSQ thin film are shown in FIG. 8.

First, referring to FIG. 7, since the content of the carbazole group of the PPCSQ is about 50 mol % that of the PVK of similar weight percentage, the UV absorption peak of the PPCSQ was about half in intensity as compared to the corresponding PVK. However, the photoluminescence (PL) intensity was similar to that of the PVK and was narrower. This means that the carbazole group of the PPCSQ exhibits much higher quantum yield than that of the PVK. It is because the more rigid siloxane main chain of the PPCSQ allows easier separation of the carbazole group than the PVK having a more flexible hydrocarbon main chain, thereby preventing formation of excimers.

This phenomenon is more prominent in the solid film. Referring to FIG. 8, since the chain mobility is more restricted in solid phase, the carbazole group of the PVK is more aggregated than in solution. This explains why the PVK shows a broader PL spectrum with lower intensity in spite of more carbazole groups than the PPCSQ.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A polysilsesquioxane having a ladder structure with photoactive groups bonded at the siloxane main chain, which is polymerized from a trifunctional silane compound having a photoactive group as monomer.

2. The polysilsesquioxane according to claim 1, wherein the photoactive group is one or more selected from a group consisting of substituted or unsubstituted phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, and a derivative thereof.

3. The polysilsesquioxane according to claim 2, which is copolymerized from monomers with different photoactive groups.

4. The polysilsesquioxane according to claim 1, wherein the monomer is represented by Chemical Formula 1: 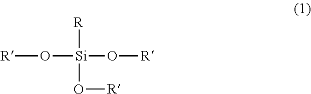
wherein R is one or more selected from a group consisting of phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, and a derivative thereof, which is connected to the Si atom directly or via an alkyl group; and R′ is substituted or unsubstituted C₁-C₃ alkyl.

5. The polysilsesquioxane according to claim 4, wherein R is connected to the Si atom via a C₁-C₁₂ alkyl group.

6. The polysilsesquioxane according to claim 1, which is represented by Chemical Formula 2: 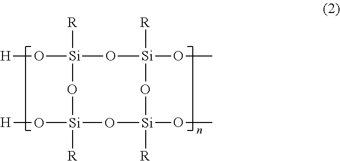
wherein R is a substituted or unsubstituted phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, and a derivative thereof; and n is from 1 to 100,000.

7. The polysilsesquioxane according to claim 6, wherein R is N-alkyl-substituted carbazole.

8. The polysilsesquioxane according to claim 1, wherein the distance between the photoactive groups is from 13 to 16 Å.

9. The polysilsesquioxane according to claim 1, wherein the average thickness of the siloxane main chain is 4 to 5 Å.

10. A method for preparing a polysilsesquioxane having a ladder structure with photoactive groups, comprising:
reacting a trifunctional silane compound with a photoactive compound to prepare a monomer; and
hydrolyzing and condensation polymerizing the monomer at the same time.

11. The preparation method according to claim 10, wherein the photoactive group is one or more selected from a group consisting of substituted or unsubstituted phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, and a derivative thereof.

12. The preparation method according to claim 10, wherein the reaction of the trifunctional silane compound with the photoactive compound is performed by reacting the trifunctional silane compound and the photoactive group in the presence of one or more catalyst(s) selected from a group consisting of KOH, NaOH, Na₂CO₃ and K₂CO₃.

13. The preparation method according to claim 10, wherein the monomer is represented by Chemical Formula 1: 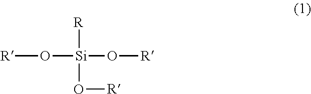
wherein R is one or more selected from a group consisting of phenylene-based, pyrene-based, rubrene-based, coumarin-based, oxazine-based, carbazole-based, thiophene-based, iridium-based, porphyrin-based, azo-based dye group bonded phenyl-based ring, a heterocyclic ring thereof, a photoactive functional group having a double or triple bond in a ring, and a derivative thereof, which is connected to the Si atom directly or via an alkyl group; and R′ is substituted or unsubstituted C₁-C₃ alkyl.

14. The preparation method according to claim 13, wherein R is connected to the Si atom via a C₁-C₁₂ alkyl group.

15. The preparation method according to claim 13, wherein the preparation is performed at room temperature to 200° C.
